(19) United States
(12) Patent Application Publication
(10) Pub. No.: US 2026/0346493 A1
(43) Pub. Date: Nov. 5, 2026

(54) Positioning unit for a hand-held circular saw

(71) Applicant: Festool GmbH, Wendlingen am Neckar (DE)

(72) Inventors: Andreas Randecker, Dettingen (DE); Wolfgang Spengler, Neidlingen (DE); David Grimm, Filderstadt (DE)

(21) Appl. No.: 19/140,035

(22) PCT Filed: Dec. 21, 2023
(86) PCT No.: PCT/EP2023/087464

§ 371 Date: Jun. 17, 2025

(30) Foreign Application Priority Data
Dec. 23, 2022 (DE) 10 2022 134 762.1
Dec. 13, 2023 (DE) 10 2023 134 937.6

(51) Int. Cl. B27B 9/04; B23D 59/00

(52) U.S. Cl. CPC B27B 9/04; B23D 59/003; B23D 59/0064

(57) ABSTRACT

The invention relates to a positioning unit (20) for a hand-held circular saw (70), wherein the positioning unit (20) has a fastening section (21) for the interchangeable fastening of the positioning unit (20) to a positive guide (10), in particular to a guide rail, and wherein the positioning unit (20) has a machine-tool stop on a stop end, in particular an initial-position limit stop (23.2) and/or an end-position stop (23.1), for limiting the motion of the hand-held circular saw (70) on the positive guide (10) in the and/or opposite to a guide direction. Any workpiece processing using the hand-held circular saw in conjunction with the positive guide is then significantly simplified if provision is made for the positioning unit (20) to have an additional component interface (29), to which an additional component (60) is, preferably interchangeably, attached.

The invention relates to a positioning unit for a machine tool, in particular a hand-held circular saw, wherein the positioning unit has, in the area of a fastening end, a fastening section for the interchangeable fastening of the positioning unit to a positive guide, in particular to a guide rail, and wherein the positioning unit has a machine-tool stop, in particular an initial-position limit stop and/or an end-position stop, on a stop end, for limiting the motion of the machine tool, in particular the hand-held circular saw, on the positive guide in the and/or opposite to a guide direction. For instance, the fastening section of the positioning unit may have a guide panel for guiding on a guide bar of the positive guide.

DE 102 51 578 B3 describes a guide rail for a hand-held circular saw, to which a positioning unit in the form of a stop piece can be attached. The stop piece can be used to define the starting position of the hand-held circular saw for a planned saw cut.

DE 10 2007 007 841 B4 discloses a hand-held circular saw, which comprises a saw blade driven by an electric motor. The saw blade is partially covered by a saw blade cover, which prevents access to the cutting edge of the saw blade. A lighting element is attached to the saw blade cover. In this way, the working area of the saw blade can be illuminated.

U.S. Pat. No. 7,185,998 discloses a hand drill, which has a mount for a lamp on its handle. The lamp can be swiveled in relation to the handle such that the light cone of the lamp can be precisely oriented to the working area of the drill.

The invention addresses the problem of providing a positioning unit of the type mentioned at the beginning, which significantly simplifies working with the machine tool, for instance the hand-held circular saw, in conjunction with the positive guide.

This problem is solved by the positioning unit having an additional component interface, to which an additional component, in particular a lamp, is, preferably interchangeably, attached.

The positioning unit according to the invention can therefore be used to precisely set the starting point or end of a planned saw cut. The user can make an additional component available directly in the working area of the machine tool via the additional component interface, to facilitate his work. For instance, he can attach a lamp to the positioning unit as an additional component. He can use it to illuminate the working area of the machine tool. This means, for instance, that he can simply align the machine tool in conjunction with the positive guide in the exact position relative to a workpiece and make a cut, in particular at a predetermined cutting length, precisely in a workpiece. The cutting result can be continuously checked during the work process. It is also conceivable that another additional component is attached to the positioning unit instead of or in addition to the lamp, for instance a chip arrester or an arrangement for the exact alignment of the positioning unit. In particular, if the additional component is interchangeably connected to the positioning unit, the user can make the appropriate work aid available as required.

According to a preferred variant of the invention, provision may be made for the positioning unit to have a cantilever arm, which is coupled to the fastening section, for instance is formed integrally therewith, and for the cantilever arm to have the additional component interface at its end area opposite from the fastening section to hold the additional component in the area of a contact edge of the positive guide, in particular the guide rail. The contact edge of the positive guide is the area along which the hand-held circular saw and its saw blade are guided during the work process. In this way, the additional component can be positioned directly in the working area of the hand-held circular saw.

For the secure attachment of the additional component, provision may be made for it to have a bearing part, which bears a connection section and that the connection section is held on a mount of the additional component interface. The additional component can be attached to the bearing part.

If provision is made for the additional component to be connected to the additional component interface in different positions and/or orientations by means of the connection section, the orientation of the additional component on the positioning unit can be varied. In this way, different mounting positions are achieved. The user then has the option of aligning and positioning the additional component appropriately, depending on the spatial conditions. Preferably, the additional component can be moved transverse to the guide direction relative to the positioning unit. The user can then set the positioning of the additional component depending on the spatial conditions.

Advantageously, provision may be made for the connection section of the additional component to have at least one snap-in mount, by means of which the connection section is fastened to a mating snap-in element of the additional component interface. In this way, the additional component can be quickly attached to or detached from the positioning unit. Advantageously, a stepped snap-in connection is established between the additional component and the additional component interface, which renders the connection of the additional component to the additional component interface in several snap-in positions possible to implement the different installation positions. This makes for a quick and easy change of the position of the additional component.

A preferred variant of the invention is such that a component support is used, which is rotatably and/or swivel connected to the bearing part by means of a bearing, and that the component support indirectly or directly bears the additional component, preferably in an interchangeable manner.

According to a possible variant of the invention, provision may be made for a detachable force-locking and/or a material bond to be effective between the connection section of the additional component and the additional component interface. The connection can be formed, for instance, by an adhesive connection, a Velcro connection and/or a magnetic connection. In particular, provision may be made for the connection section of the additional component to have at least one magnet and for the additional component interface to have a counter-magnet, which interacts with the magnet of the connection section and/or secures the connection section in at least one position relative to the additional component interface.

According to the invention, provision may be made for the additional component to comprise, for instance, a lamp, a cutting width compensator, a laser cutting line indicator or a chip collection hood. If a chip collection hood is used, it is advantageous if provision is made for it to have a collection body, to which a discharge connection is coupled, wherein the discharge connection preferably has an interchangeable coupling element for connecting a dust extraction system. The chips that are trapped in the chip collection hood during machining can be discharged in an orderly manner via the discharge connection.

According to a variant of the invention, provision may be made for the cutting width compensator to have a marking edge on at least one lug and for the lug to be coupled directly or indirectly to the connection section via a component support. The marking edge makes it easy for the user to see the cutting width compensation to take the cutting width of the saw blade into account before the work process. The marking edge preferably extends in parallel to the guide direction and/or in parallel to a guide panel of the fastening section.

A particularly simple and precise setting can be achieved if provision is made for the at least one cutting width compensator to be moved, preferably infinitely variably and/or without tools, relative to the positioning unit via a sliding guide, wherein the setting direction of the sliding guide preferably extends transverse to the feed direction of the hand-held circular saw, i.e. in the guide direction.

A possible variant of the invention can be such that a cutting-length setting element is, preferably movably, fastened to a carrier or the additional component interface, wherein the cutting-length setting element is held in the area of the fastening section or the/an cantilever arm of the positioning unit, and that the cutting-length setting element projects beyond the fastening section in or in the opposite direction to the guide direction. This has particular advantages, for instance, if a plunge saw is to be used to perform a plunge cut in a workpiece.

As already described above, the positioning unit has the machine-tool stop on the stop end, in particular the initial-position limit stop, for limiting the motion of the machine tool on the positive guide in the direction opposite to a guide direction.

A positioning unit designed in this way can therefore be used to precisely set the starting point of a planned saw cut. This has particular advantages, for instance, if a plunge cut, for example a concealed plunge cut, is to be made in a workpiece (safely) using a plunge saw. The starting point of the cut is determined by the initial-position limit stop.

In a preferred variant of the invention, provision may also be made for the positioning unit according to the invention to be used to precisely set the cutting end of a planned saw cut. The end of the cut can then be advantageously determined by the machine-tool stop, which then forms an end-position stop.

For instance, the starting point of the cut can be determined by the machine-tool stop (initial-position limit stop). At the start of a planned machining operation, the positive guide/guide rail is placed on the workpiece to be machined. The positioning unit can then be connected to the positive guide/guide rail. The planned cutting depth is then set on the cutting-length setting element. The marking on the cutting-length setting element corresponding to the planned cutting depth is then aligned with a marking on the workpiece that represents the planned starting point of the cut. The hand-held circular saw can now be placed on the positive guide/guide rail and moved in the opposite direction to the planned machining direction. This motion is limited by the machine-tool stop (initial-position limit stop) of the positioning unit. A corresponding counter stop of the hand-held circular saw strikes against the former. The hand-held circular saw is now precisely positioned for performing the saw cut. Because the counter stop of the hand-held circular saw rests against the machine-tool stop at the start of workpiece machining, the circular handsaw is prevented from deflecting backwards (and possibly upwards) in an uncontrolled manner against the planned machining direction when engaging with the workpiece. This ensures the quality of the cut made and also reduces the risk of injury to the user. In the same way, a positioning unit according to the invention can also be used to limit or precisely set the planned cutting end.

It is advantageous to calibrate the positioning unit before starting a planned machining operation on the workpiece to be machined. For this purpose, the positive guide/guide rail is placed on a test workpiece at the start of calibration. The positioning unit is then placed on the positive guide/guide rail, positioned with the machine-tool stop against the counter stop of the hand-held circular saw and then secured to the positive guide/guide rail. The hand-held circular saw is then used to make a test cut, in particular a plunge cut, in a test workpiece, which has a rear and a front end. Optionally, the hand-held circular saw can now be removed from the positive guide/guide rail. The cutting-length setting element is then adjusted relative to the machine-tool stop in a fixed position relative to the test workpiece such that a marking, advantageously a marking corresponding to the planned cutting depth, of the cutting-length setting element is oriented to the rear or front end of the test cut, depending on whether the positioning unit was disposed behind or in front of the hand-held circular saw in the machining direction.

It is conceivable that the carrier to which the cutting-length setting element is adjustably attached and/or the cutting-length setting element is/are interchangeably connected with the positioning unit. In this way, different carriers, each of which is adapted to the dimensions of a saw blade and/or a specific hand-held circular saw, can be attached to the positioning unit. A user therefore has the option of using different saw blades on their hand-held circular saw and/or different machine types on a positioning unit. Depending on the geometry of the saw blade, the user then selects the appropriate carrier and connects it to the positioning unit.

Additionally or alternatively, the cutting-length setting element can also be connected to the carrier in a replaceable manner. This allows the cutting-length setting element suitable for a specific type of hand-held circular saw and/or saw blade to be selected and connected to the carrier and/or positioning unit. In other words, the user has the option of using a given cutting-length limiting device with different hand-held circular saws and/or different saw blades.

According to a preferred embodiment of the invention, provision may be made for the positioning unit to have a kick-back stop for a counter-stop of the hand-held circular saw. A kick-back stop is characterized in that it prevents the machine tool from lifting off in the opposite direction to the workpiece surface (e.g. in the direction opposite to the fastening end of the fastening section). In combination with the machine-tool stop, the kick-back stop ensures that the hand-held circular saw is held securely in place. In particular, in this way, the reliable insertion of a plunge cut into a workpiece is achieved. In so doing, the critical plunging process is safeguarded. Once the hand-held circular saw has been moved into its plunge position, it can be adjusted in the guide direction and the planned saw cut can be made in the workpiece. The machine tool is then moved out of the effective range of the kick-back stop.

In the context of the invention, the kick-back stop can be used to secure the counter-stop of the machine tool relative to the positioning unit in a form-fitting manner and/or in a force-locked manner.

According to a preferred variant of the invention, provision may be made for the kick-back stop to have a height stop, which is disposed spaced apart from the fastening end, forming a spacing area, and which is oriented to face the latter. In this way, the counter stop of the machine tool can be retracted into the area between the fastening end and the height stop and reliably positioned there. The height stop overlaps the counter stop of the machine tool in a form-fitting manner. This creates a form fit between the positioning unit and the hand-held circular saw in the direction opposite to the top face of the workpiece to be machined.

One conceivable variant of the invention is such that the kick-back stop is disposed in the area of the initial-position limit stop, wherein preferably provision is made for the initial-position limit stop to be disposed in the area of the clearance space below the height stop. This results in an optimized force flow and a compact structural assignment of the initial-position limit stop to the kick-back stop.

According to a variant of the invention, provision may be made for the fastening section to bear a clamping element, which is disposed in the area of the fastening end and which can be adjusted between a release position and a clamping position, for the fastening section to have at least one recess, which is open towards the fastening end, and for the clamping element to engage at least sectionally with the recess in the clamping position and to open an engagement area of the recess in the release position.

Positive guides, preferably guide rails, are usually equipped with a rib-shaped protrusion extending in the guide direction, which protrusion forms an undercut guide groove. The positioning unit can now be placed across the rib-shaped protrusion with its downwardly open recess, transverse to the longitudinal extent of the undercut groove, wherein the clamping element then plunges into the undercut groove. The fastening section can now be secured in relation to the guide rail by moving the clamping element from the release position to the clamping position. The clamping element is braced in the undercut groove. In this design variant, the fastening section of the positioning unit can therefore be placed at any position on the positive guide/guide rail and secured thereto. This means that it is not necessary for the fastening section to be laboriously threaded in from the face of the undercut groove.

In such a variant of the invention, it may in particular also be provided that the clamping element has a base part, wherein the base part has a mount, to which a handle is coupled for adjusting the clamping element, and wherein the base part has arms on diametrically opposite ends. A lug for limiting the adjustment of the clamping element can be disposed on at least one of the arms, wherein each of the lugs bears at least one arm stop. The clamping element can be braced via the two arms, driven by the handle, to clamping surfaces disposed on the arms on opposite ends of the undercut groove. This creates a particularly strong clamp connection.

A cutting-length limiting device according to the invention can be such that the fastening section of the positioning unit has a mount, on which a tensioning element is held, that the tensioning element bears a tensioning piece on a lever spaced apart from a support part, and that a/the handle, for instance a rotary knob, can be adjusted relative to the support part to move the tensioning piece from a release position to a tensioning position. This measure can also be used to the achieve reliable attachment of the positioning unit to the positive guide/guide rail. The fastening is particularly effective if the tensioning element is used in addition to the above-mentioned clamping element, which is braced in the undercut groove. It is particularly advantageous if the handle is used to tension both the clamping element and the tensioning element. In this way, a user-friendly fastening of the positioning unit is achieved.

If provision is made for the/a tensioning element held on the fastening section to have an alignment element, which preferably has an alignment bevel, wherein the alignment bevel extends in the guide direction of the positive guide and is at an angle of less than 90 ° to the fastening end of the positioning unit in the tensioning position of the tensioning element, then the positioning unit can be oriented precisely in a position relative to the positive guide/guide rail. In this case, the alignment bevel is positioned against a body edge extending in the guide direction of the positive guide/guide rail. In this way, the tensioning element and thus the entire positioning unit are aligned precisely with the positive guide/guide rail. Preferably, the body edge is formed by the aforementioned protrusion, which forms the undercut groove.

To simplify the adjustment process of the cutting-length limiting device even in obscure places, provision may be made for the positioning unit to have a cantilever arm, which has another carrier spaced apart from the fastening section and/or the carrier, and that the two carriers each bear a cutting-length setting element. In particular, the cutting-length setting elements may be disposed on the opposite ends of the positioning unit extending in the guide direction and thus on the longitudinal ends of the guide rail. With such an arrangement, even if the saw blade is positioned close to the wall during machining, the cutting-length setting element on the opposite end can be aligned with a mark on the workpiece.

Preferably, the two cutting-length setting elements can be interchangeably attached to the carriers.

Additionally or alternatively, provision may also be made for one or both carriers to be interchangeably attached to the positioning unit, in particular without tools.

Preferably, provision may also be made for both cutting-length setting elements and/or both carriers to be of identical design such that identical parts can be used.

A particularly precise alignment of the positioning unit can be achieved if provision is made for the carrier(s) to have a guide, on which a guide section of the cutting-length setting element is adjustably held, and for the adjustment element to be adjusted in the and/or in the opposite direction to the guide direction by means of an adjustment element on the guide, preferably in an infinitely variable way.

According to the invention, the cutting-length setting element may have markings, for instance in the form of a scale, which reflect the adjustable cutting depths of the hand-held circular saw. The user can determine the cutting depth set on the hand-held circular saw and then align the corresponding cutting depth marking on the cutting-length setting element with a mark on a test workpiece. The user can then use the hand-held circular saw to make a test cut in the test workpiece. If the starting point of the cut does not match the mark, the user can make a correction on the adjustment element and thus adjust the cutting-length setting element accordingly. In this way, for instance, changes in the diameter of the saw blade as a result of resharpening processes or wear can be compensated for.

Preferably, provision may be made for the scale to be applied to a bottom face of the cutting-length setting element facing a workpiece to be machined and the scale is disposed in an area of the cutting-length setting element which is formed by a transparent material. In this way, parallax errors can be minimized.

A particularly simple and reliable design is achieved if provision is made for a threaded section, preferably in one piece, to be coupled to the guide section of the cutting-length setting element, which together with a thread of the adjustment element forms an adjusting gear for the infinitely variable adjustment of the cutting-length setting element in the and/or in the opposite direction to the guide direction, wherein preferably provision is made for the cutting-length setting element to have a scale. As mentioned above, the scale may be such that it marks different depth of cut settings that may correlate with depth of cut markings on the machine tool being used.

A possible variant of the invention can be such that the carrier and/or the cutting-length setting element has a sacrificial section which is designed and prepared to project into the sawing area of the hand-held circular saw in such a way that a saw blade of the hand-held circular saw cuts out a sawn-in area from the sacrificial section, wherein preferably provision is made for the sacrificial section to be integrally formed on the carrier and/or the cutting-length setting element.

With such a configuration, the positioning unit can be precisely set for a specified cutting depth and a saw blade mounted on the hand-held circular saw. For this purpose, a test cut is first produced in a workpiece, in particular a test workpiece, wherein the sacrificial section is sawn with the specified cutting depth infeed. In this way, the starting point of the sawn area exactly reflects the starting point of the cut. Now the starting point of the sawn area can be aligned with a mark on a workpiece to be machined. Then, during the subsequent saw cut, the starting point of the cut can be made at exactly the specified point on the workpiece to be machined. Advantageously, the remaining, non-sawed area of the sacrificial section also acts as a splinter guard when it is positioned so that it rests on the top face of the workpiece.

It is also conceivable that the user aligns the marking of the cutting-length setting element corresponding to the set cutting depth with the starting point of the sawn area of the sacrificial section. In this way, the exact markings on the cutting-length setting element can now also be aligned with a mark of the workpiece for other cutting depths. In other words, the sawn-in area provides a precise calibration marking against which the cutting-length setting element can be aligned.

If the sacrificial section is molded in one piece onto the carrier, it can be easily manufactured, for instance as a plastic injection-molded part.

A stable fastening of the positioning unit to a guide rail is achieved in a simple manner if provision is made for a guide support to be connected to the fastening section, which has a recessed, preferably groove-shaped, linear guide mount, wherein the linear guide mount is disposed at a distance from an engagement section formed by the attachment section and designed in the form of a projecting protrusion.

The problem of the invention is also solved by a guide assembly for a hand-held circular saw having a positioning unit according to any of claims 1 to 16 and a positive guide in the form of a guide rail, wherein the guide rail has a guide groove extending in the guide direction and/or a guide bar extending in the guide direction, wherein the guide rail forms a longitudinal fastening end extending in the guide direction and, opposite thereto, a cutting edge end having a contact edge, wherein the positioning unit is detachably connected to the guide rail in the area of the longitudinal fastening end by means of the fastening section, and in that the additional component is held laterally next to the contact edge in the area of the cutting edge end, at least sectionally.

If provision is made for a rear positioning unit to be disposed on the guide rail and for a further positioning unit to be disposed spaced apart therefrom in the guide direction, wherein preferably both positioning units have an additional component interface, then the user can attach the additional component to both or optionally to the interface suitable for the user.

The invention is explained in greater detail below based on exemplary embodiments shown in the drawings. In the figures,

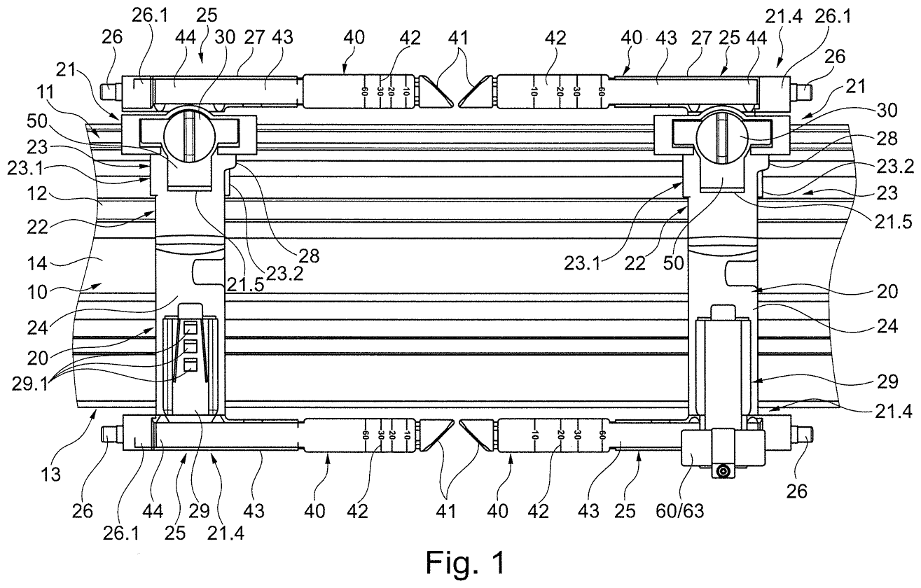

FIG. 1 shows a top view of a construction unit having a positive guide and a front and a rear cutting-length limiting device,

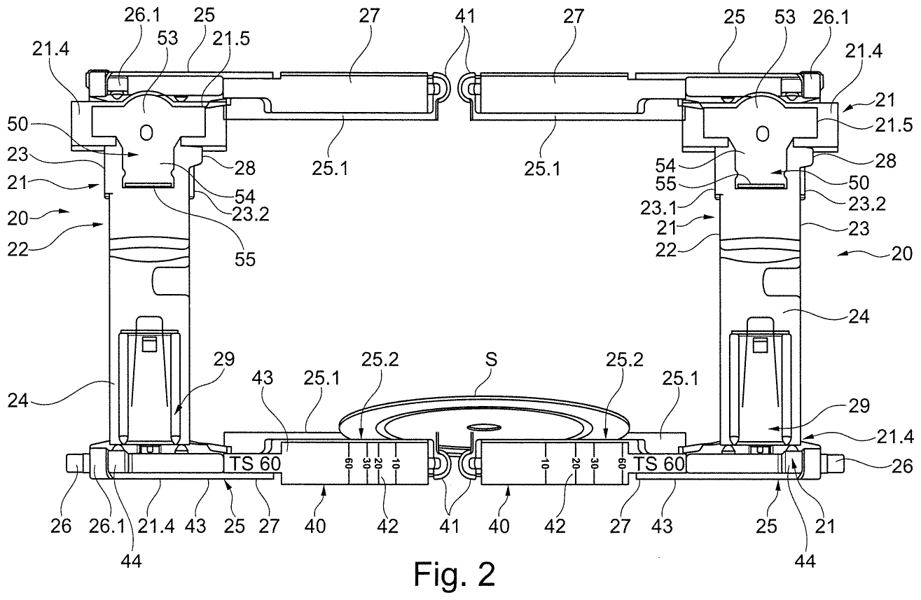

FIG. 2 shows a further design variant of a cutting-length limiting device for the front and rear limitation of a cut in plan view,

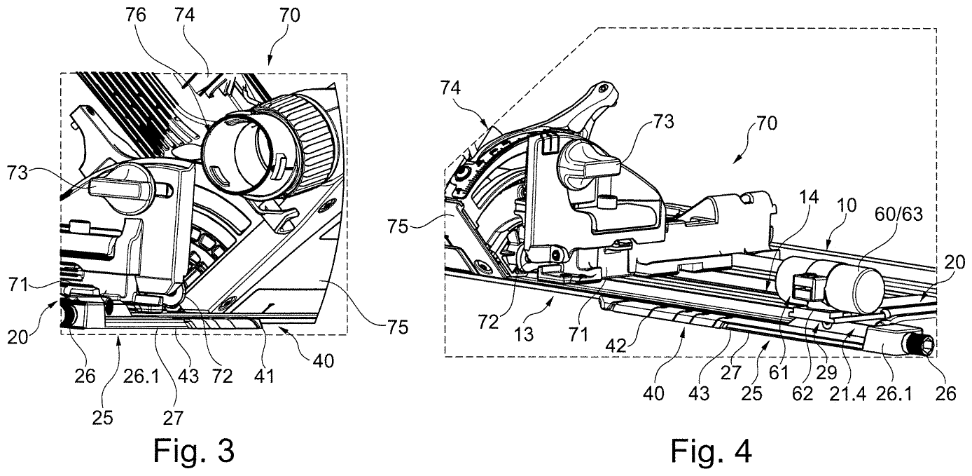

FIG. 3 shows a detailed perspective rear view of the cutting-length limiting device of FIG. 1 with an inclined hand-held circular saw,

FIG. 4 shows a perspective front view of the machine unit of FIG. 3,

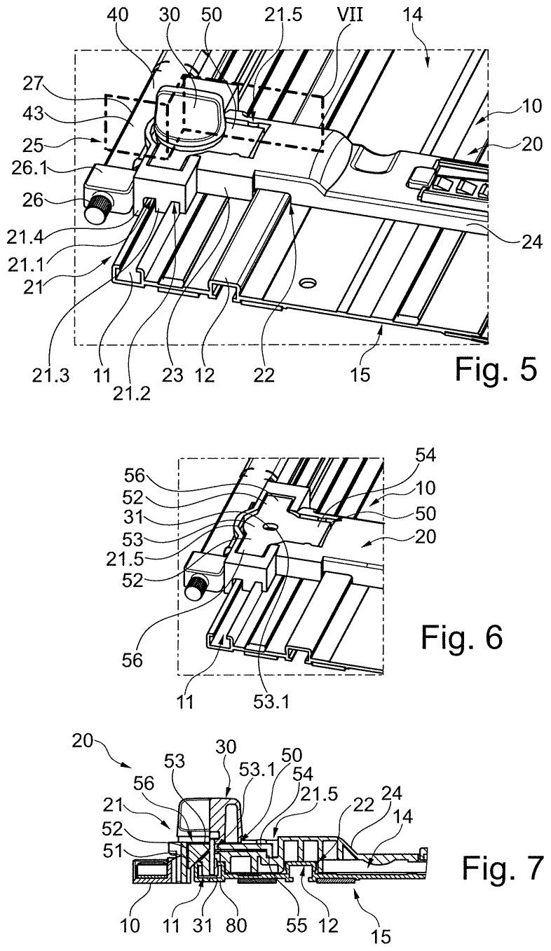

FIG. 5 shows a detailed perspective view of the assembly of FIG. 1,

FIG. 6 shows the representation of FIG. 5 without handle,

FIG. 7 shows a sectional view through the assembly of FIG. 5 transverse to the machining direction,

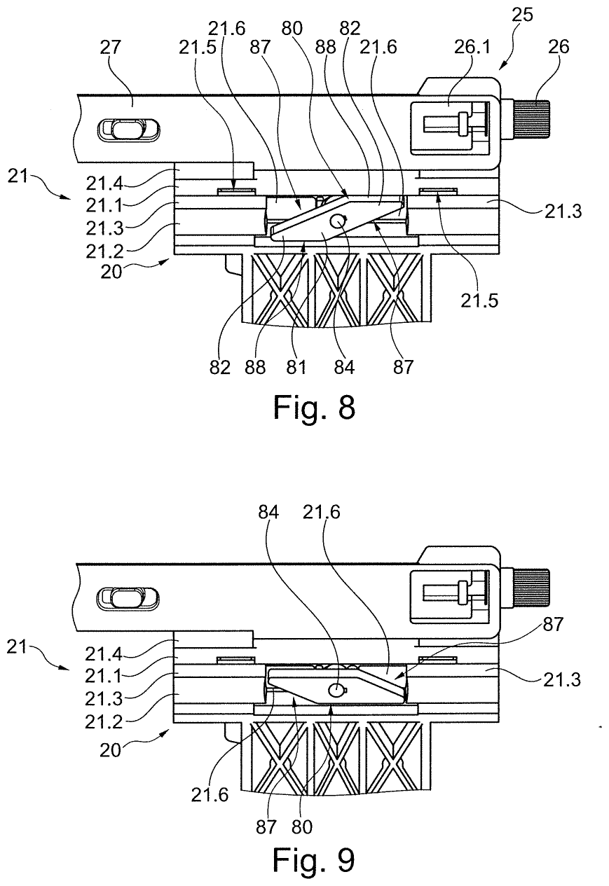

FIGS. 8 and 9 show a section of a positioning unit of the assembly of FIG. 1, viewed from below in various operating positions,

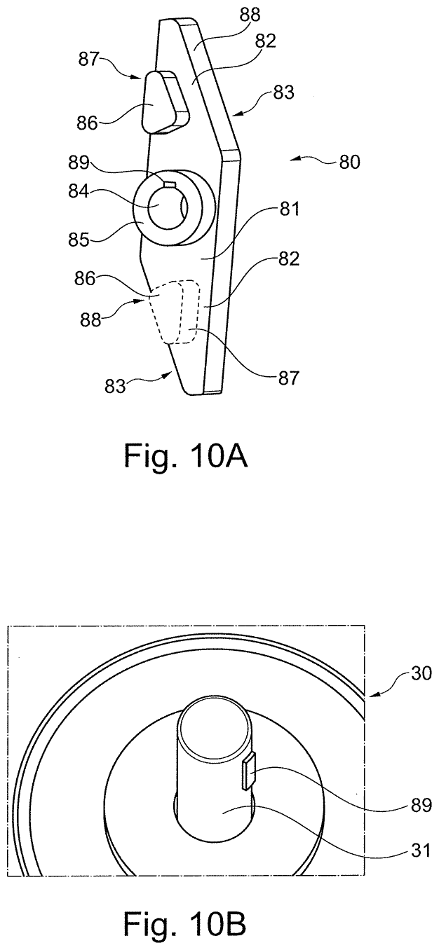

FIG. 10A shows a perspective view of a clamping element,

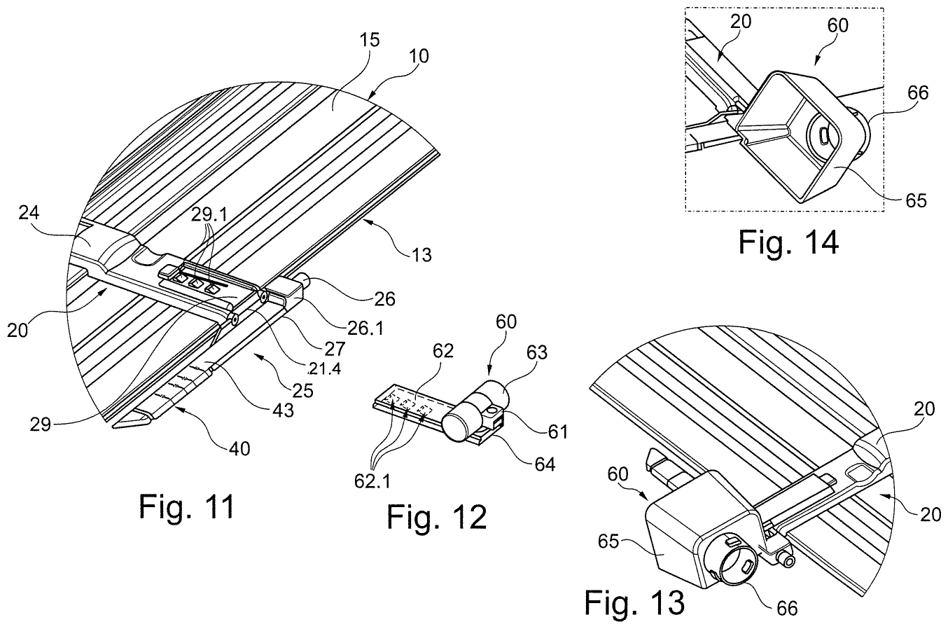

FIG. 11 shows a detailed representation of a positioning unit,

FIG. 12 to 14 show various additional components as attachments to the positioning unit as shown in FIG. 11,

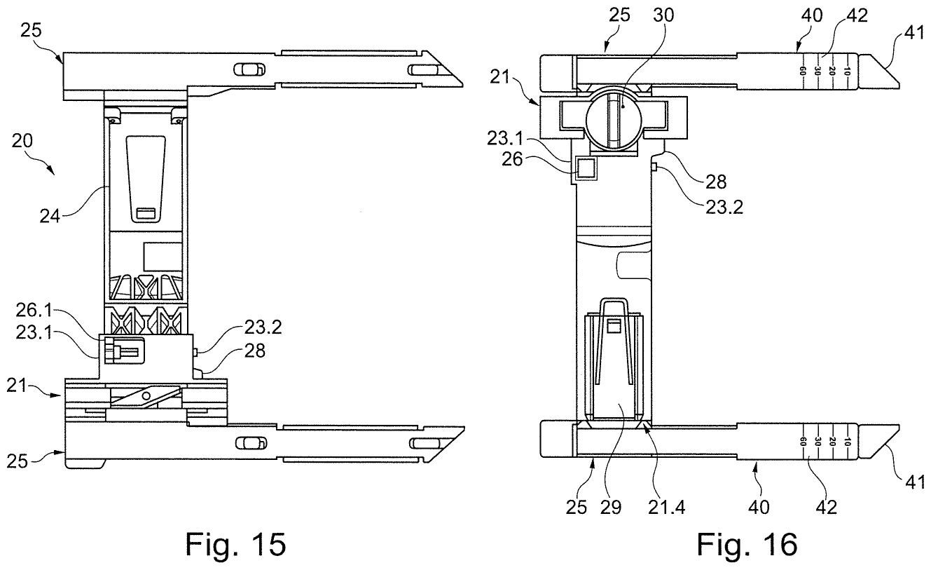

FIG. 15 shows an alternative design variant of a positioning unit from below

FIG. 16 shows the positioning unit of FIG. 15 from above,

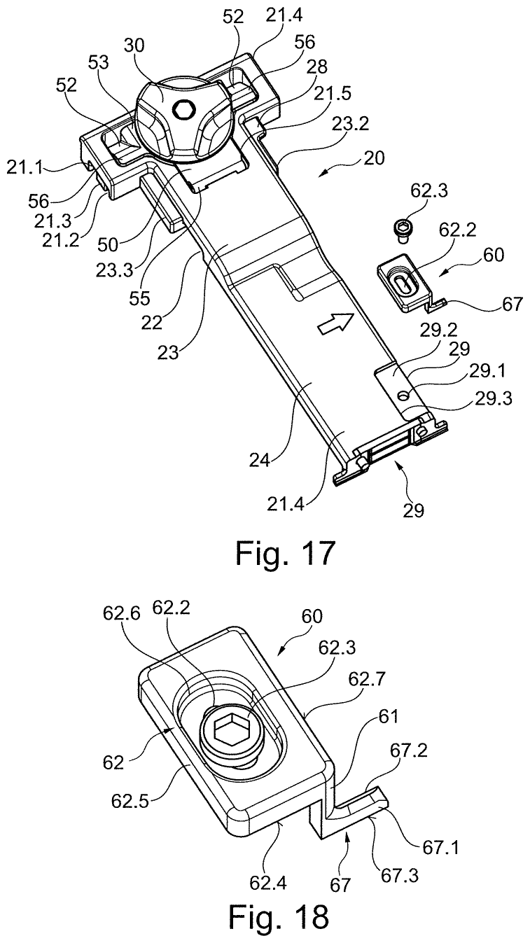

FIG. 17 shows a perspective view of a further design variant of a positioning unit with an additional component,

FIG. 18 shows an enlarged view of the additional component of FIG. 17,

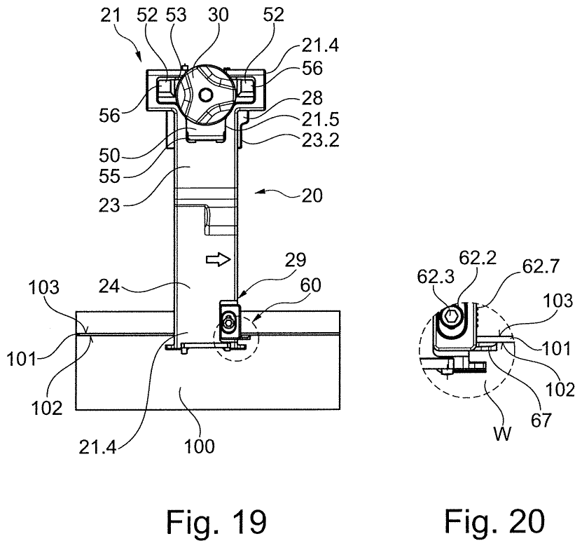

FIG. 19 shows the positioning unit of FIG. 17 in schematic assignment to a workpiece, viewed from above and in a first operating position,

FIG. 20 shows an enlarged view of a detail marked in FIG. 19,

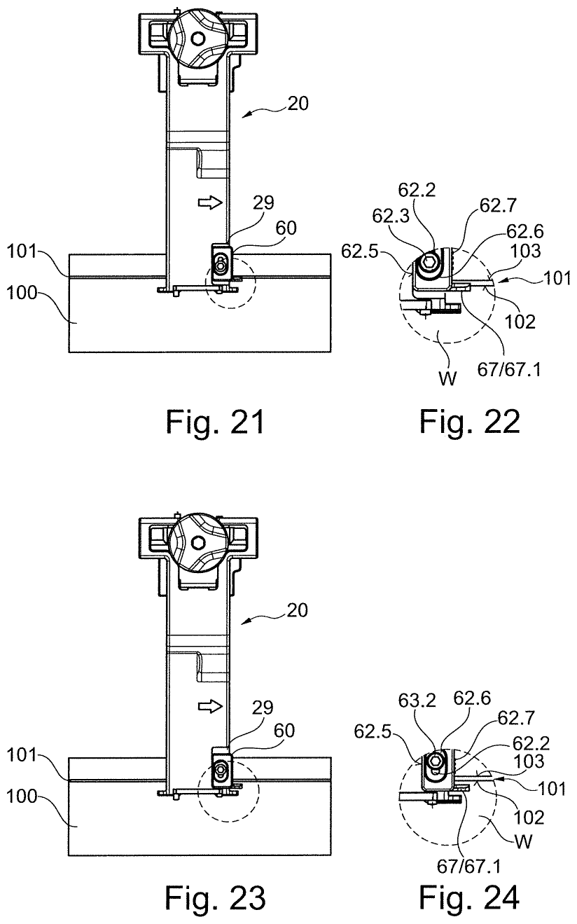

FIG. 21 shows the positioning unit of FIG. 17 in schematic assignment to a workpiece, viewed from above and in a second operating position,

FIG. 22 shows an enlarged view of a detail marked in FIG. 21,

FIG. 23 shows the positioning unit of FIG. 17 in schematic assignment to a workpiece, viewed from above and in a third operating position,

FIG. 24 shows an enlarged view of a detail marked in FIG. 23,

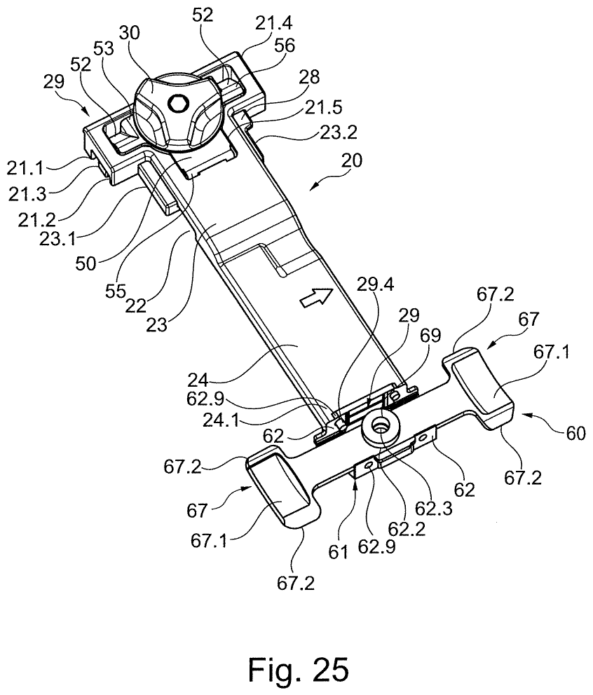

FIG. 25 shows a perspective view of a further design variant of a positioning unit with an additional component,

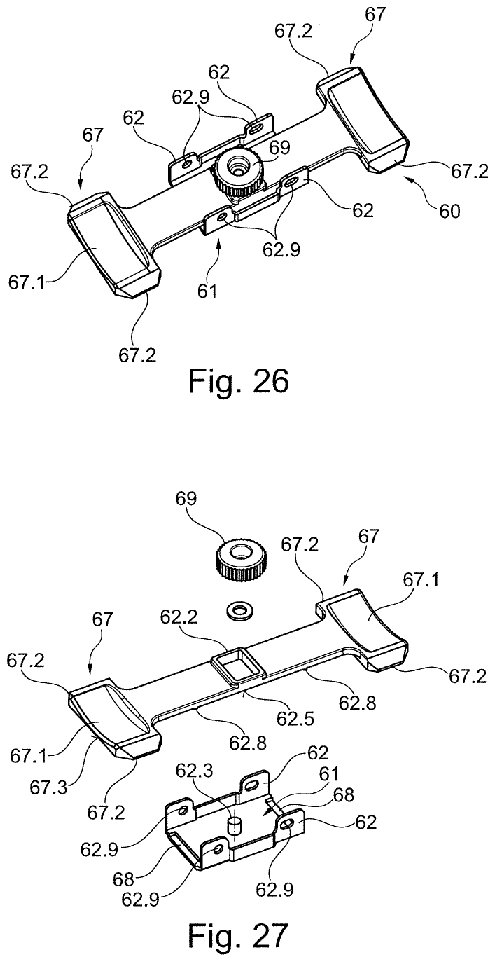

FIG. 26 shows an enlarged view of the additional component of FIG. 25,

FIG. 27 shows an exploded view of the additional component of FIG. 26,

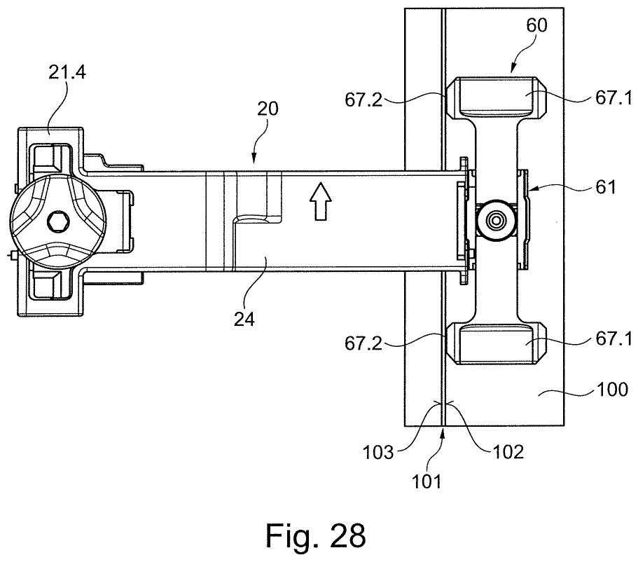

FIG. 28 shows the positioning unit of FIG. 25 in schematic assignment to a workpiece, viewed from above and in a first operating position,

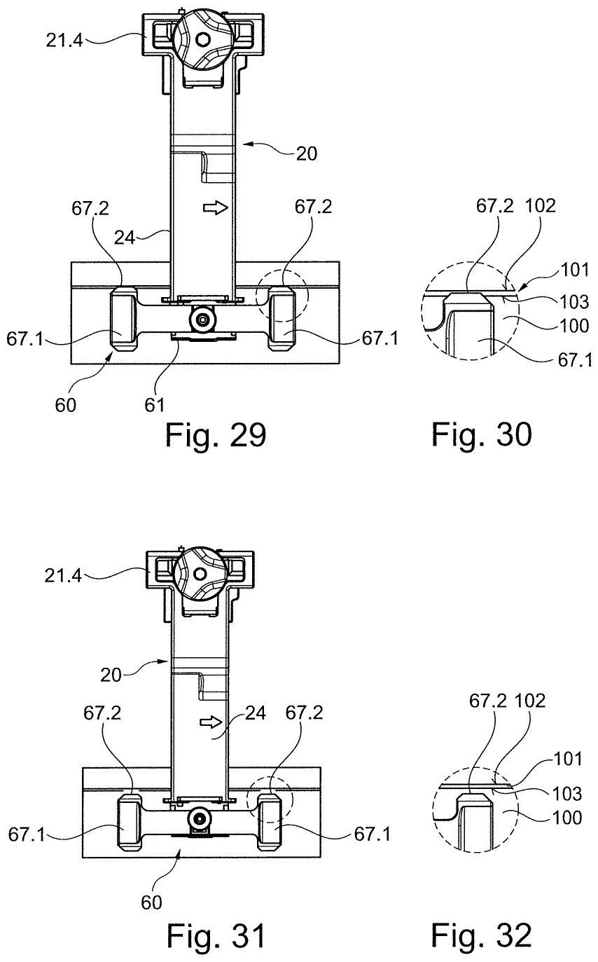

FIG. 29 shows the positioning unit of FIG. 25 in schematic assignment to a workpiece, viewed from above and in a second operating position,

FIG. 30 shows an enlarged view of a detail marked in FIG. 29,

FIG. 31 shows the positioning unit of FIG. 25 in schematic assignment to a workpiece, viewed from above and in a third operating position,

FIG. 32 shows an enlarged view of a detail marked in FIG. 31

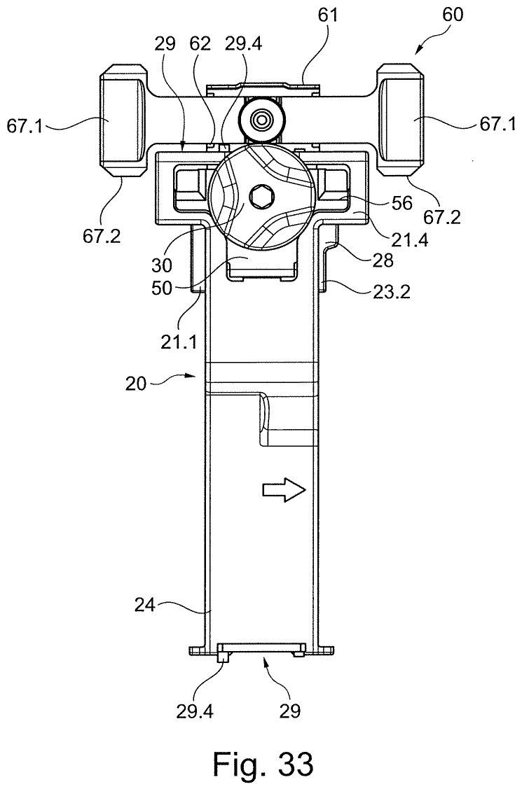

FIG. 33 shows the positioning unit of FIG. 17 with a modified assignment of the additional component,

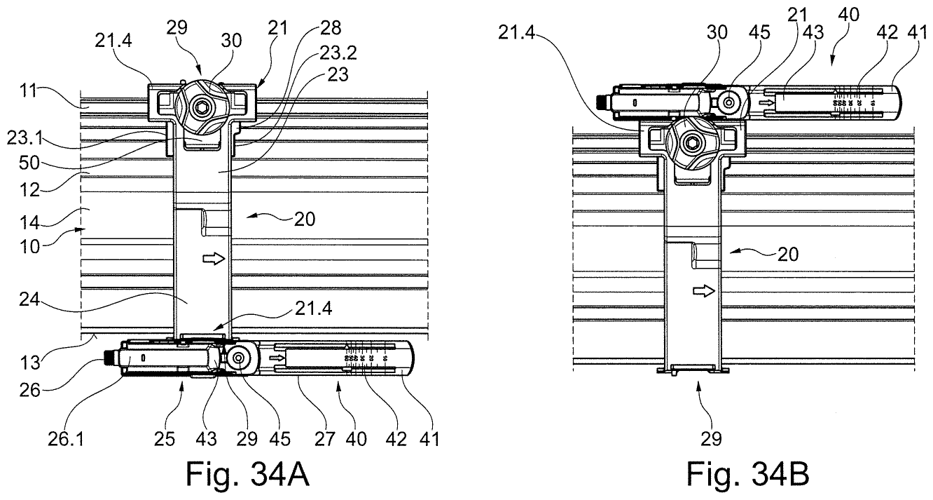

FIG. 34a shows a further design variant with a positioning unit to which an additional component having a cutting-length setting element is assigned,

FIG. 34b shows the arrangement of FIG. 34a in a modified mounting position,

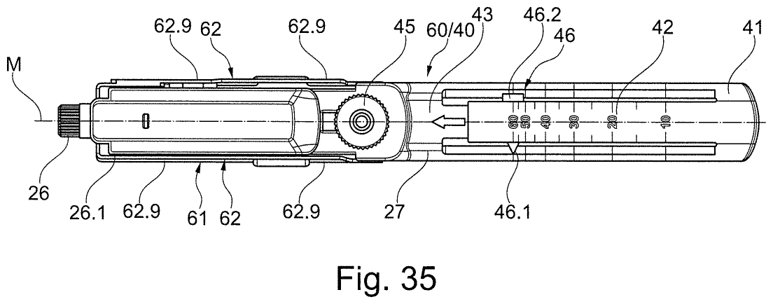

FIG. 35 shows an enlarged view of the additional component shown in FIGS. 34a and 34b,

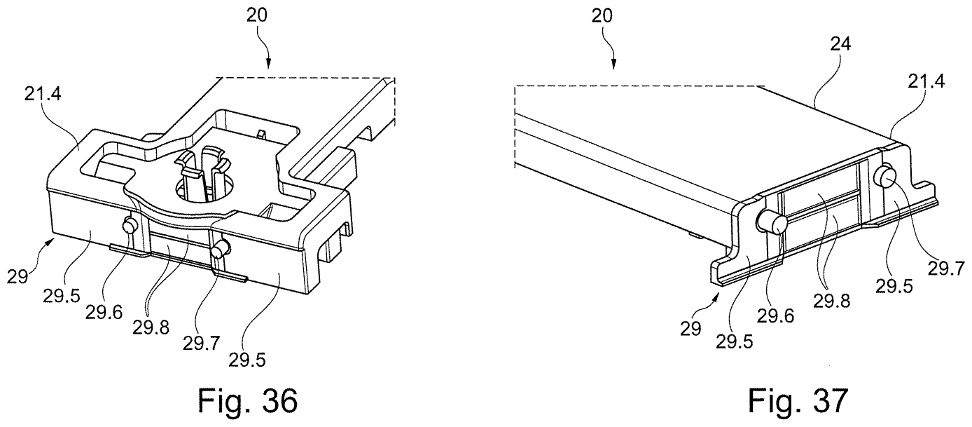

FIGS. 36 and 37 each show an enlarged detail of the positioning unit of FIG. 34a/34b and

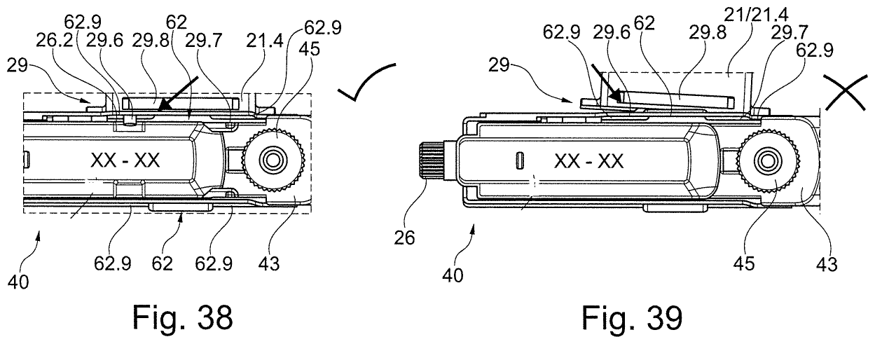

FIGS. 38 and 39 show enlarged detailed views of the installation situations of the positioning unit of FIG. 34a/34b, wherein an error avoidance mechanism is also illustrated there (poka-yoke principle).

FIG. 1 shows an assembly for use with a hand-held circular saw 70. The hand-held circular saw (??) 70 can be designed in particular as a plunge-cut saw or a pendulum action saw.

The assembly has a positive guide 10, which is designed in the form of a guide rail. The assembly also has a cutting-length limiting device with a positioning unit 20.

The guide rail has (see FIG. 5) a support surface 15 on the bottom face as support on a workpiece and an upper guide end 14 on the opposite end. The hand-held circular saw 70 (see FIGS. 3 and 4) can be placed on the guide surfaces of the guide end 14 and guided in the direction of the longitudinal extent of the guide rail.

For positive guidance of the hand-held circular saw 70, the guide rail has an upwardly open guide groove 11, which extends in the direction of the longitudinal extent of the guide rail and is designed as an undercut groove. Furthermore, the guide rail has a guide bar 12 spaced apart and in parallel to the guide groove 11. The guide bar 12 is designed as a rib-shaped protrusion that projects beyond the guide end 14 and also extends in the direction of the longitudinal extent of the guide rail.

As FIG. 1 further illustrates, at least one positioning unit 20 can be attached to the top face of the guide rail. The positioning unit 20 shown on the left in FIG. 1 is used to limit the starting point of a planned saw cut. The positioning unit 20 shown on the right in FIG. 1 is used to limit the end of the planned cut.

To begin with, the left-hand positioning unit 20 is explained in more detail below. As FIG. 1 illustrates, the positioning unit 20 has a fastening section 21. The fastening section 21 is designed to be secured to the guide rail. In this case, the fastening section 21 can be detachably connected to the guide groove 11 and/or the guide bar 12.

As FIG. 5 illustrates, an engagement section 21.3 on the fastening section 21, which engages with the guide groove 11, can be used to attach the positioning unit 20 to the guide groove 11. Recesses 21.1, 21.2 can preferably be provided on both ends of the engagement section 21.3. The recesses 21.1, 21.2 accommodate the groove walls projecting beyond the guide end 14 of the guide rail.

A clamping mechanism that produces a clamping connection at any position in the direction of the longitudinal extent of the guide groove 11 can be used to secure the fastening section 21 to the guide groove 11 and thus to the positive guide 10. The clamping mechanism is preferably supported by the fastening section 21 of the positioning unit 20.

The clamping mechanism can, for instance, have a tensioning element 50 and/or a clamping element 80, by means of which a clamping connection with the guide rail is established.

As FIGS. 5-7 show, the tensioning element 50 may bear a tensioning piece 55 on a lever 54, wherein the tensioning piece 55 rests on a tensioning surface to form a counter bearing to form the tensioning connection, such that the clamping element 80 can be braced to the guide rail.

Provision may be made for the tensioning element 50 to be adjustably mounted in a mount 21.5 of the fastening section.

Provision may be made for a support part 53 to be connected to the lever 54. The tensioning element 50 can have lateral lugs 56, which project on opposite ends of the support part 53 and which are adjustably mounted in the area of the mount 21.5 of the fastening section 21, for instance to form a sliding seat or a swivel bearing.

Preferably, an alignment element 51 can be provided on the tensioning element 50. The alignment element 51 is designed and equipped to interact with a mating surface, the guide rail. The mating surface preferably extends in the direction of the longitudinal extent of the guide rail. In this way the tensioning element can be aligned with the alignment element 51 in the exact position relative to the mating surface when it is in its tensioning position, as shown in FIG. 7. In this way, the tensioning element and thus the entire positioning unit 20 are aligned with the guide rail.

In one design variant, the alignment element 51 of the tensioning element 50 can have an alignment surface, which extends in the direction of the longitudinal extent of the guide rail and which forms an angle of less than 90° with the support surface 15 at the bottom face of the guide rail. In this way, the tensioning element 50 self-aligns with the mating surface of the guide rail during the tensioning process.

FIG. 7 illustrates that the alignment element 51 can be formed by legs 52 which are coupled to the support part 53, for instance via the lugs 56, wherein the legs 52 extend in the direction towards the support surface 15 and are disposed spaced apart from one another. In the assembled state, the legs 52 at least partially overlap a lateral limiting edge of the guide rail and/or at least one groove wall of the guide groove 11.

The aforementioned alignment surface of the tensioning element 50 can be formed by the alignment element 51 and/or the legs 52.

FIG. 6 illustrates that the tensioning element 50 can have an aperture 53.1, preferably in the area of the support part 53. A handle 30, in this case designed as a rotary knob (see FIG. 5) by way of example, is disposed in the area of the top face of the tensioning element 50. This handle 30 can be supported directly or indirectly on the top face of the support part 53. A threaded section 31 of the handle 30 extends through the aperture 53.1, wherein the threaded section 31 is screwed into a threaded mount below the support part 53. In this way, the threaded section 31 can be screwed into the mating thread by turning the handle 30. The handle 30 then presses on the support part 53, such that the tensioning piece 55 and/or alignment element 51 of the tensioning element 50 is/are pressed onto the top face of the guide rail, thereby securing the positioning unit 20 relative to the guide rail.

Additionally or alternatively, provision may be made for the positioning unit 20 to be detachably connected to the guide rail in the area of its fastening section 21 by means of a clamping element 80.

The clamping element 80 is shown in FIGS. 8, 9 and 10. As this representation shows, the clamping element 80 is disposed in the area of the bottom face, i.e. the end of the fastening section 21 facing the support surface 15, and can be adjusted between the clamping position shown in FIG. 8 and the release position shown in FIG. 9. Preferably, the clamping element 80 can be adjusted by means of the/a handle 30. The clamping element 80 can be designed such that it has one or more clamping surfaces 88, which are used to brace the clamping element 80 in the clamping position in the guide groove 11. In this exemplary embodiment, the clamping element 80 has clamping surfaces 88 on opposite ends, by means of which it can be braced to the opposite, facing(??) , interior lateral surfaces of the guide groove 11.

FIG. 10A shows a possible configuration of a clamping element 80. As this diagram illustrates, the clamping element 80 has a base part 81. Arms 82 can be formed on opposite ends of this base part 81. The two arms 82 form the clamping surfaces 88, wherein the clamping surfaces 88 are preferably disposed on one lateral face of each arm 82.

The clamping element 80 may have a protrusion 85 having a mount 84 in the area of its base part 81. The mount 84 can, for instance, be designed as a threaded mount for the threaded section 31. Preferably, the threaded section 31 is screwed into the mount 84 with a friction element 89 in between. For instance, the friction element can be formed by a thread lock, such as a plastic layer.

As FIGS. 10A, 10B show, the friction element can be inserted into a groove of the mount 84 of the clamping element 80 or a groove of the threaded section 31 of the handle 30.

As FIG. 10A shows, the clamping element 80 has an arm stop 87 on one stop end of each of its arms 82 and a bevel 83 on the opposite clamping end.

As FIGS. 8 and 9 show, the clamping element 80 can be inserted into the fastening section 21 from the bottom face. For this purpose, the fastening section 21 has a clamping element mount that is open at the bottom and can be disposed between two engagement sections 21.3, for instance a front engagement section 21.3 in the machining direction and a rear engagement section 21.3 in the machining direction. The protrusion 85 of the clamping element 80 is rotatably mounted in the clamping element mount. The axis of rotation preferably extends perpendicular to the guide end 14 of the guide rail. To attach the clamping element 80 to the positioning unit 20, the threaded section 31 of the handle 30 is screwed into the mount 84.

FIG. 8 shows the clamping position of the clamping element 80. In the clamping position, the clamping surfaces 88 are in contact with the opposite inner ends of the guide groove 11 when the positioning unit 20 is placed on the guide rail. The required tensioning pressure is applied via the handle 30, the threaded section 31 of which is screwed into the mount 84.

The aforementioned bevels 83 ensure that the clamping element 80 does not rest in the transition area of the guide groove 11, which is formed between the base of the guide groove 11 and the inner ends of the guide groove 11, in the clamping position.

FIG. 9 shows the initial position of the clamping element 80, wherein the clamping element 80 is in its swiveled-in position. In this position, the arm stops 87 of the clamping element 80 rest against stops 21.6, which the fastening section 21 forms in the area of the clamping element mount. The stops 21.6 are oriented such that the clamping element 80 is aligned in the direction of the two engagement sections 21.3 and does not project into the recesses 21.1, 21.2 or does not project in such a way that insertion of the clamping element 80 into the guide groove 11 in the direction perpendicular to the guide end 14 is impeded. This ensures that the positioning unit 20 can be placed on the guide rail in any position in the direction of the longitudinal extent of the guide rail and does not have to be laboriously threaded into the end face of the guide groove 11.

Accordingly, the positioning unit 20 can be placed at the desired position on the guide rail, wherein the clamping element 80 and the engagement sections 21.3 project into the guide groove 11. The handle 30 can then be adjusted and thus both the tensioning piece 55 can be tensioned and the clamping element 80 can be moved from the rest position shown in FIG. 9 to the clamping position shown in FIG. 8. In this way, the positioning unit 20 is connected in a reliable and aligned manner with the guide rail.

If the clamping position is released, the positioning unit 20 can be displaced relative to the positive guide 10 in the direction of the longitudinal extent of the positive guide 10 and thus in the direction parallel to the guide direction of the hand-held circular saw. The longitudinal extent of the fastening section 21 therefore also extends in or in parallel to the guide direction. The positioning unit 20 is guided on the positive guide 10 by means of at least one guide panel (in FIG. 5 at reference number 22) of the positioning unit 20, which extends in the guide direction and which is guided, for instance, on the guide bar 12.

The aforementioned friction element 89, which is provided between the threaded section 31 and the mount 84 of the clamping element 80, ensures that the clamping element 80 can be swiveled from the rest position as shown in FIG. 9 into the clamping position as shown in FIG. 8, and that the threaded connection can only then be tightened in an operationally reliable manner.

FIGS. 1 and 7 illustrate that the positioning unit 20 can have a linear guide mount 22, preferably in the area of the fastening section 21, which linear guide mount is incorporated into the positioning unit 20 in the form of a downwardly open groove. The cross-sectional design of the linear guide mount 22 is adapted to the cross-sectional design of the guide bar 12. FIGS. 5 and 6 illustrate that the guide bar 12 in the assembly position is mounted in the linear guide mount 22 to orient the positioning unit 20 with respect to the guide rail in this way as well.

Preferably, both the linear guide mount 22 and the clamping element 80 and/or the tensioning element 50 are disposed on a guide support 23 of the positioning unit 20. A cantilever arm 24 can be connected to the guide support 23, which cantilever arm is guided from the fastening end of the guide rail to a contact edge 13 of the guide rail opposite from the fastening end, as illustrated in FIG. 1.

FIG. 5 shows that the fastening section 21 may comprise a holder 21.4. The holder 21.4 is used to hold a carrier 25. The carrier 25 is preferably held laterally next to the fastening end of the guide rail. The carrier 25 can be integrally connected to the holder 21.4 or preferably detachably.

The carrier 25 bears a cutting-length setting element 40. The cutting-length setting element 40 may have a guide section 43, which is guided on a guide 27 of the carrier 25 in the direction of the longitudinal extent of the guide rail.

An adjustment element 26 can be provided on the carrier 25 to adjust the cutting-length setting element 40. A gear can be effective between the adjustment element 26 and the cutting-length setting element 40, by means of which gear an infinitely variable adjustment of the cutting-length setting element 40 in the direction of the longitudinal extent of the guide rail relative to the carrier 25 is rendered possible. It is conceivable that the carrier 25 has a threaded adjustment element mount 26.1 (see also FIG. 8). The cutting-length setting element 40 has a threaded section 44, which interacts with this thread to form the gear. The adjustment element 26 can, as in this case, have a handle part that is disposed on the carrier 25 in an easily accessible manner to enable a user to operate it. By turning the adjustment element 26, the cutting-length setting element 40 can be adjusted in the direction of the longitudinal extent of the guide rail.

FIG. 8 illustrates that the carrier 25 can have a window-shaped aperture into which a stop of the carrier 25 projects. The adjustment motion of the cutting-length setting element 40 is limited at the longitudinal ends of the aperture.

FIG. 1 shows that the cutting-length setting element 40 can have a scale 42, on which various cutting depth settings are marked. These cutting depth settings correlate with cutting depth settings indicated on a setting scale of the hand-held circular saw 70 used. The type of hand-held circular saw 70 can be marked on the cutting-length setting element 40, as shown above. By way of example, in the exemplary embodiment the cutting-length setting element 40 correlates with the hand-held circular saw of type “TS 60” (or “XX-XX” in FIGS. 38, 39).

Preferably, the cutting-length setting element 40 is made of a transparent material, at least in the area of the scale 42, and the scale 42 is applied to the bottom face of the end of the cutting-length setting element 40 facing the workpiece, similar to a protractor triangle, to minimize parallax errors. Alternatively, a cutting-length setting element 40, for instance a non-transparent one, can also have a scale printed on the top face.

A support element 41 can be provided at the longitudinal end of the cutting-length setting element. This support element 41 is used to support the cutting-length setting element 40 on the top face of a workpiece to be machined.

The cutting-length setting element 40 can be designed in such a way that it can be connected to the carrier 25 in a replaceable manner. This ensures that the positioning unit 20 can be used in conjunction with different types of hand-held circular saws 70. Additionally or alternatively, for this purpose provision may also be made for the carrier 25 to be connected to the fastening section 21 in a replaceable manner.

FIG. 1 further illustrates that the holder 21.4 can be disposed on the cantilever arm 24 of the positioning unit 20. Advantageously, the holder 21.4 disposed on the cantilever arm 24 can be a further holder 21.4 (in addition to the holder disposed on the fastening section 21). A further carrier 25, which holds a further cutting-length setting element 40 to the end of the contact edge 13 of the guide rail, is mounted in the further holder 21.4. Advantageously, the further holder 21.4 is identical in design to the holder 21.4 and/or the further carrier 25 is identical in design to the carrier 25 and/or the further cut length adjustment element 40 is identical in design to the cut length adjustment element 40.

Preferably, the carrier 25 has a fastening interface that enables the carrier 25 to be attached both to the holder 21.4 of the fastening section 21 and to the holder 21.4 of the cantilever arm 24. A user can then optionally attach a carrier 25 having a cutting-length setting element 40 on the fastening end and/or on the end of the contact edge 13. In this way, the user can choose the arrangement most favorable to the user.

Identical parts can be used if the beams 25 are of the same design.

Also preferably, the cutting-length setting elements 40 are essentially designed as identical parts.

It is also conceivable that a cutting-length setting element 40 can only be used on the end of the contact edge 13.

FIG. 1 also shows that the positioning units 20 each have a machine-tool stop for a hand-held circular saw 70. The machine-tool stops are preferably disposed in the area of the fastening section 21 and more preferably in an area that is formed between the guide groove 11 and the guide bar 12 to permit a stable assignment to the guide rail. The machine-tool stop of the left-hand positioning unit forms an initial-position limit stop 23.2 for limiting the motion of the machine tool on the positive guide 10 in the opposite direction from a guide direction. The machine-tool stop of the right-hand positioning unit forms an end-position stop 23.1 for limiting the motion of the machine tool on the positive guide 10 in the guide direction.

Furthermore, a kick-back stop 28 can be provided, which is preferably disposed in the area of the fastening section 21 and which is further preferably assigned to the initial-position limit stop 23.2. Advantageously, the kick-back stop 28 is disposed above the initial-position limit stop 23.2. The kick-back stop 28 has an overlapping section, which is held at a distance from a bottom face of the positioning unit 20 and/or the guide end 14 of the guide rail to form a mounting section. A counter stop of the hand-held circular saw 70 used can be inserted into this mounting section. The counter stop extends under the kick-back stop 28 when the hand-held circular saw 70 is in contact with the initial-position limit stop 23.2.

FIGS. 3 and 4 illustrate that the hand-held circular saw 70 can have a conventional design. For instance, the hand-held circular saw 70 can have a base plate 71, which it is used to place it on the guide rail. The base plate 71 is designed in such a way that it is guided both on the guide groove 11 and on the guide bar 12 and is therefore displaceably guided on the guide end 14. In this way, the hand-held circular saw 70 can be moved in the direction of the longitudinal extent of the guide rail by means of the base plate 71.

A swivel assembly 74 of the hand-held circular saw is swivel mounted on the base plate 71 by means of a swivel bearing 72. The swivel axis of the swivel bearing 72 extends in parallel to the longitudinal extent of the guide rail. To secure the swivel assembly 74, the swivel bearing 72 has a knob 73, which secures the swivel assembly 74 in the desired swivel position.

The drawings according to FIGS. 3 and 4 further show that the swivel assembly 74 has a saw blade cover 75, behind which a saw blade S of the hand-held circular saw 70 is mounted in a protected manner. The saw blade cover 75 usually has a lateral end open at the bottom, through which the saw blade S can be swiveled into its plunge position. The saw blade cover 75 can be provided with an extraction connection 76 for a chip-extraction system.

The cutting depth set on the hand-held circular saw 70 can be read off a setting scale for the precise adjustment of the starting point of the planned saw cut. There is a correlating value on the scale 42 of the cutting-length setting element 40 for this read value. This correlating value is now aligned with a mark on the workpiece to be machined. The mark indicates the planned starting point of the cut. If the cutting-length limiting device is aligned with this mark, the handle 30 can be used to lock it to the guide rail.

As mentioned above, to make the planned saw cut the hand-held circular saw 70 can be attached to the positioning unit 20 shown on the left in FIG. 1. The base plate 71 of the hand-held circular saw 70 rests against the initial-position limit stop 23.2 of the positioning unit 20. The kick-back stop 28 overlaps a counter stop of the base plate 71 of the hand-held circular saw 70. The hand-held circular saw 70 can now be activated. The swivel assembly 74 of the hand-held circular saw 70 is then swiveled about a swivel axis extending transverse to the guide rail by the amount of the planned cutting depth. The saw blade S cuts into the workpiece, wherein the starting point of the cut of the planned saw cut is then produced in the plunge position, which is congruent with the mark on the workpiece to be machined. The hand-held circular saw 70 can then be moved in the guide direction to fully make the planned saw cut into the workpiece. The guide direction in FIG. 1 extends from left to right.

The initial-position limit stop 23.2 prevents the hand-held circular saw 70 from deflecting against the guide direction when the saw blade S plunges into the workpiece. The kick-back stop 28 prevents the hand-held circular saw 70 from deflecting in a direction perpendicular to the guide end 14. This prevents the hand-held circular saw 70 from moving in an uncontrolled manner relative to the guide rail during this critical plunging process.

As mentioned above, the positioning unit 20 can have two cutting-length setting elements 40. Accordingly, the positioning unit 20 can be aligned with a mark on the workpiece either on the left or right side as viewed in the guide direction. If, for instance, the contact edge 13 disposed in the area of the saw blade S is difficult to see (e.g. when sawing close to a wall), the positioning unit 20 can be aligned with the mark on the workpiece by means of the cutting-length setting element 40 disposed on the fastening end.

A further cutting-length limiting device having a positioning unit 20 can be used to limit the end of the cut. This positioning unit 20 can again have a fastening section 21 for connection to the guide rail. The positioning unit 20 can have at least one cutting-length setting element 40. Preferably, the fastening section 21 with its cantilever arm 24 is of the same design as the positioning unit 20 described above for limiting the starting point of the cut. Also preferably the same carriers 25 may be installed on both positioning units 20, for which purpose corresponding holders 21.4 can be provided on both positioning units 20. In addition, the cutting-length setting elements 40 may also be designed essentially as identical parts, wherein the scales 42 of the cutting-length setting elements 40 for limiting the starting point of the cut and the end of the cut differ, however, since different scaling is necessary due to the swivel kinematics of the hand-held circular saw 70, as FIG. 1 illustrates.

As already explained above, the cutting-length limiting device for limiting the end of the cut has an end-position stop 23.1 opposite the initial-position limit stop 23.2. This end-position stop 23.1 is oriented to a counter stop of the hand-held circular saw 70, wherein the counter stop is preferably formed by the base plate 71.

The cutting-length limiting device for limiting the end of the cut, like the cutting-length limiting device for limiting the starting point of the cut, is aligned with a mark on the workpiece that indicates the planned end of the cut. To avoid repetition, reference is made to the explanations above. If the hand-held circular saw 70 is now advanced in the guide direction, the guide motion at the end of the cut is limited by the end-position stop 23.1. The saw blade S has then reached the end of the cut and the saw cut is complete.

It is now possible that, for instance, due to resharpening/wear of the saw blade S or other influences, even if the scales 42 are correctly aligned with the marks, the planned starting point of the cut or the planned end of the cut is not produced exactly in the workpiece.

In this case, a correction can be made using the adjustment element 26 by means of a test cut. Accordingly, the test cut is first made at a specified cutting depth in a test workpiece. The dimension of the offset of the starting point/end of the cut is then determined in relation to the scale value of the cutting-length setting element 40 corresponding to the cutting depth. This offset can be corrected using the adjustment element 26. The cutting-length setting element 40 is then again precisely set in relation to the carrier 25 and thus in relation to the fastening section 21.

FIGS. 34a and 34b show a further invention. As this representation shows, a positioning unit 20 is used. This positioning unit 20 may be designed as described above and/or designed as described in the claims.

To avoid repetition, reference is therefore made to the above explanations or to the claims, which can also apply in the same way to the positioning unit 20 of FIGS. 34a and 34b.

As the figures illustrate, the positioning unit 20 has at least one additional component interface 29. The additional component interface 29 can be provided on the cantilever arm 24 and/or on the holder 21.4. Preferably, an additional component interface 29 is provided on both the holder 21.4 and the cantilever arm 24.

The design of the additional component interface 29 is shown in FIGS. 36 and 37 by way of example. FIG. 36 illustrates the additional component interface 29 in the area of the holder 21.4 and FIG. 37 the additional component interface 29 in the area of the cantilever arm 24.

As FIG. 36 shows, the additional component interface 29 has at least one stop 29.5. Furthermore, the additional component interface 29 may have at least one coding element 29.6, 29.7. In this exemplary embodiment, two coding elements 29.6, 29.7 are used, which can have different geometric shapes. As FIG. 36 shows, the first coding element 29.6 may have a smaller size than the second coding element 29.7. The second coding element 29.7 can project further beyond the outside of the holder 21.4, which results in the different geometry in this case. The coding can also be represented in different geometries, e.g. the first and second coding elements can have different diameters, i.e. the vertical length perpendicular to the interface 29 of the coding elements does not necessarily have to be different.

FIG. 36 also illustrates that the additional component interface 29 can have at least one magnet 29.8 (or a counter-magnet, for instance a ferromagnetic part). In this exemplary embodiment, the magnet 29.8 is disposed in the area between the two coding elements and/or in the area between the two stops 29.5.

The design of the additional component interface 29 in the area of the cantilever arm 24 (see FIG. 37) is essentially equal to the design of the additional component interface 29 that was explained above with reference to FIG. 36, which is why reference is made to the above explanations. In particular, the two coding elements 29.6, 29.7 can be symmetrically identical to the central longitudinal axis of the positioning unit.

A cutting-length setting element 40, as shown as an example in FIG. 35, can be interchangeably attached to the additional component interfaces 29.

The cutting-length setting element 40 is essentially equal to the cutting-length setting element 40 as described with reference to FIGS. 1 to 16, which is why reference can be made to the above explanations.

Therefore, only the differences shall be explained below. The cutting-length setting element 40 again has a guide 27, on which a scale 42 is slidably guided. The scale 42 can again be adjusted linearly via the adjustment element 26, wherein the adjusting motion extends in the direction of the central longitudinal axis M of the cutting-length setting element 40.

As FIG. 35 shows, a pointer 46 can be assigned to the scale 42. The pointer 46 can be moved along the scale 42 in the direction of the central longitudinal axis M. In this exemplary embodiment, the pointer 46 in FIG. 35 is set to the value “60”. This corresponds to a cutting depth of the hand-held circular saw 70 of 60 mm. The pointer may bear a marking element 46.1, which can be aligned with a mark on a workpiece. For easier operation, the pointer 46 has a handle element 46.2. Preferably, provision is made for the pointer 46 to be made of a transparent material, at least sectionally, in order to minimize parallax errors.

As mentioned above, the adjustment element 26 can be used to move the scale 42. A clamping element 45 is used to secure the setting position after the scale 42 has been set. Preferably, the clamping element 45 is designed to secure, preferably clamp, the scale 42 to the guide section 43.

The drawings further illustrate that the cutting-length setting element 40 forms an additional component 60. This additional component 60 comprises, among other things, a component support 61, on which the guide section 43 is held. The component support 61 has at least one connection section 62.

In this exemplary embodiment, two connection sections 62 are provided on opposite ends. Preferably, the two connection sections 62 are provided symmetrically to the central longitudinal axis M on both ends of the component support 61. The at least one connection section 62 is provided with recesses 62.9, wherein the recesses 62.9 are designed to match the geometry of the coding elements 29.6, 29.7 of the additional component interface 29.

FIG. 38 shows that a coding mount 26.2 can be provided on a cutting-length setting element 40 in order to receive at least one of the coding elements 29.6, 29.7. In the exemplary embodiment shown, the coding element 29.6, which has a larger projection beyond the additional component interface 29, is guided through the recesses 62.9 in the connection section 62 and projects into the coding mount 26.2. In this way, the connection section 62 connects to the stops 29.5 of the assigned additional component interface 29. The magnetic force of the magnet 29.8 holds the connection section 62 securely on the additional component interface 29.

The coding elements 29.6, 29.7 may be geometrically designed in such a way that they also form alignment elements by means of which the correct positional assignment of the cutting-length setting element 40 to the positioning unit 20 is ensured.

FIG. 39 illustrates the function of the two coding elements 29.6, 29.7. As this figure illustrates, the cutting-length setting element 40 attached to the additional component interface 29 does not have a coding mount 26.2, i.e., it cannot be mounted on the positioning unit 20. A user thus recognizes that the user has not assigned the appropriate additional component 60 to the additional component interface 29.

Via the coded additional component interface 29, it is possible in particular to assign the respective cutting-length setting elements 40 with the scales 42 suitable for the initial-position limit stop 23.2 or the end-position stop 23.1 to the positioning unit 20, which forms the initial-position limit stop 23.2, and to the positioning unit 20, which forms the end-position stop 23.1 for the planned saw cut.

FIG. 2 shows another variant of the invention. Identical components are marked with the same reference numerals such that reference can be made to the above explanations to avoid repetition.

The two exemplary embodiments differ in particular with regard to the design of the carriers 25. In the exemplary embodiment shown in FIG. 2, the carrier 25 has a sacrificial section 25.1. The sacrificial section 25.1 is designed such that it protrudes into the cutting area of the saw blade S, as illustrated in FIG. 2.

To produce a test cut, the guide rail described above is placed on the top face of a workpiece that is used as a test workpiece. The two positioning units 20 are attached to the guide rail as shown in FIG. 2. The hand-held circular saw 70 is positioned against the left-hand positioning unit 20 (i.e. the initial-position limit stop 23.2 and/or the kick-back stop 28). A test cut is then made in the workpiece at a predetermined cutting depth (60 mm in this exemplary embodiment), wherein the saw blade S of the hand-held circular saw 70 is plunged into the workpiece. The hand-held circular saw 70 is then moved in the guide direction towards the right-hand positioning unit 20 until it stops at the end-position stop 23.1.

A test cut having a starting point of the cut and an end of the cut is made in the workpiece, wherein the saw blade S also simultaneously cuts into the sacrificial sections 25.1 and cuts out a sawn-in area 25.2 from the sacrificial sections 25.1 of the two carriers 25. The longitudinal ends of the sawn area 25.2 in the guide direction show the starting point and the end of the test cut.

The marking on the scale 42 of the cutting-length setting element 40 (here: 60 mm), which correlates with the cutting depth, can now be aligned with the actual starting point of the cut or the actual end of the cut (of the sawn area (25.2)). The scale 42 is thus precisely calibrated. Accordingly, the scale for a subsequent saw cut can be precisely aligned with the mark on a workpiece to be processed.

In the case of planned machining performed with a cutting depth corresponding to the test cut, the longitudinal ends of the sawn area can be brought into alignment with the mark on the workpiece to achieve the exact alignment of the positioning units 20. This is advantageous for so-called repeat cuts, where the same cuts are to be made repeatedly in several workpieces.

FIG. 4 illustrates that the carriers 25, at least in the area of the contact edge 13 of the guide rail, are preferably designed in such a way that the top faces of the cutting-length setting elements 40 are disposed offset at least sectionally with respect to the guide end 14 of the guide rail in the direction of the support surface 15 at the bottom face. This allows the swivel assembly 74 to be swiveled relative to the base plate 71 at least in a partial swivel range without the swivel motion of the swivel assembly 74 being impeded by the cutting-length setting elements 40.

As FIG. 11 illustrates, at least one of the cutting-length limiting devices may be equipped with one or more additional component interfaces 29. The additional component interface 29 can be located anywhere on the cutting-length limiting device. Preferably, the additional component interface 29 can be disposed in the area of the positioning unit 20 on the end opposite from the fastening section 21, i.e. in the area of the contact edge 13 of the guide rail.

As FIG. 11 shows, the additional component interface 29 can be disposed in the area of the cantilever arm 24 or be formed thereby. The additional component interface 29 can be designed as a plug-in mount. It can be formed in the area between the top face of the cantilever arm 24 and the bottom face of the cantilever 24. In this way, the interface is integrated into the positioning unit 20 to save space.

A component support 61 can be connected to the positioning unit 20 via the additional component interface 29, preferably interchangeably (without tools), as illustrated for instance in FIG. 12.

FIG. 12 further shows that the component support 61 can have a connection section 62. The connection section 62 is formed and prepared to be connected to the positioning unit 20 via the additional component interface 29. For instance, the connection section 62 can be designed as a plug-in lug, as shown in FIG. 12. This plug-in lug can be plugged into the plug-in mount of the additional component interface 29.

The additional component interface 29 may be configured such that, at the user's option, the connection section 62 may be connected to the additional component interface 29 in various positions or orientations.

FIG. 12 illustrates that the connection section 62 has snap-in mounts 62.1. The snap-in mounts 62.1 are disposed spaced apart from one another such that the connection section 62 can be mounted in various positions on the positioning unit 20 transverse to the longitudinal orientation of the guide rail, and in particular can be snapped-in in various positions by means of mating snap-in elements 29.1 disposed in the additional component interface 29.

It is also conceivable that the connection section 62 is adjustably held on the additional component interface 29 in an infinitely variable manner.

Additionally or alternatively, provision may also be made for the component support 61 to be connected to the connection section 62 via a bearing part 64. A pivot and/or swivel bearing can be formed in the area between the bearing part 64 and the component support 61. In this way, the component support 61 can be positioned in different orientations in relation to the bearing part 64 and thus in relation to the guide rail. In the exemplary embodiment shown, the swivel axis extends vertically to the guide end 14 of the guide rail. In principle, it is also conceivable that the pivot bearing could be designed as a ball joint.

FIG. 12 illustrates that an additional component, in the form of a lamp 63, can be connected to the component support 61.

The lamp 63 can preferably be attached to the positioning unit 20 in the area of the contact edge 13, which is used to limit the end of the cut. This is shown in FIG. 1. Accordingly, the lamp 63 is disposed in such a way that the light path of the lamp is disposed counter to the guiding motion of the hand-held circular saw 70. Consequently, the lamp 63 illuminates the working area of the hand-held circular saw 70, i.e. the area in which the saw blade S penetrates the workpiece.

Similar to a flashlight, a mechanical on/off switch function may be provided on the lamp 63. Additionally or alternatively, provision may also be made for a vibration sensor to be present on one of the machine components, advantageously on the lamp 63 itself. By means of a control circuit connected to the vibration sensor, the lamp 63 can be switched on when the hand-held circular saw 70 is activated or switched off when the hand-held circular saw 70 is deactivated.

It is also conceivable that a radio receiver is present on the lamp 63, which switches the lamp on and/or off when it receives a radio signal, for instance from the hand-held circular saw 70.

Additionally or alternatively, a sawdust collection hood 65 can be attached to the or a further additional component interface 29 as an additional component. Preferably, a component support 61, which has a connection section 62 for connection to the additional component interface, is again used.

It is conceivable that the connection section 62 is equal in principle in its structure to the connection section 62 according to FIG. 12, such that the chip collection hood 65 can be secured in various adjustment positions.

It is also conceivable that the bearing part 64 shown in FIG. 12 is designed in such a way that the component support 61 is detachably connected to the bearing part 64. Then, instead of the component support 61, which bears the lamp 63, the component support 61 according to FIG. 13, which bears the sawdust collection hood 65, can be connected directly or indirectly to the bearing part 64 in a kit-like manner. A pivot and/or swivel bearing may again be formed, which can be used to swivel the chip collection hood 65 relative to the bearing part 64.

FIGS. 13 and 14 show that the sawdust collection hood 65 has a catch body. The catch body can have a discharge connection 66. For instance, a suction hose of a chip removal system, such as a vacuum cleaner, can be connected to the discharge connection 66.

In the area of the contact edge 13, the chips cut off from the workpiece are ejected against the guide direction of the hand-held circular saw 70 during machining operation. These chips can be at least partially trapped in the chip collection hood 65 and discharged in an orderly manner via the discharge connection 66.

FIGS. 15 and 16 show a further design variant of a cutting-length limiting device having a positioning unit 20. In FIGS. 15 and 16, identical components are marked using the same reference numerals. To avoid repetition, reference can be made to the above explanations. Therefore, only the differences to the exemplary embodiment shown in FIGS. 1-14 are discussed below

FIGS. 15 and 16 show an alternative embodiment of the cutting-length limiting device, in which not the cutting-length setting element 40 but the initial-position limit stop 23.2 can be adjusted.

The cutting-length limiting device again has a positioning unit 20, which is designed to be connected to the positive guide 10 as described above. On the positioning unit 20 there are again lateral carriers 25, which bear a cutting-length setting element 40. In particular, the cutting-length setting element 40 with its scale 42 can be held on the carrier 25 such that it cannot be displaced, in particular cannot be displaced in the direction of the cutting direction of the hand-held circular saw 70. The initial-position limit stop 23.2 is disposed on the cutting-length limiting device, in particular on the positioning unit 20 and further preferably in the area of the fastening section 21, to align the scale 42 relative to a mark on the workpiece. In contrast to the exemplary embodiment described above, the initial-position limit stop 23.2 is held adjustably on the positioning unit 20. For this purpose, provision may be made, for instance, for an adjustment element 26 to be used, which the positioning unit 20 bears, in particular in the area of the fastening section 21, which can be used to adjust the initial-position limit stop 23.2. The setting direction of the initial-position limit stop 23.2 is in the direction of the cutting direction of the hand-held circular saw 70, for instance from left to right (and vice versa) in FIG. 16. The adjustment of the initial-position limit stop 23.2 on the positioning unit 20 is preferably infinitely variable. For this purpose, provision may be made for a threaded connection to be effective between the initial-position limit stop 23.2 and the adjustment element 26. FIG. 15 illustrates that an adjustment element mount 26.1 can be present on the positioning unit 20, in which the adjustment element 26 is mounted in a protected manner and accessible from above (FIG. 16).

To align the positioning unit 20, the stop of the hand-held circular saw 70, for instance the base plate 71, is placed against the initial-position limit stop 23.2. A test cut can then be made in a test workpiece. If the starting point of this test cut does not match the corresponding marking on the scale 42, the entire positioning unit 20 can be moved relative to the hand-held circular saw 70 using the adjustable initial-position limit stop 23.2 until the starting point of the cut matches the corresponding marking (corresponding to the depth setting on the hand-held circular saw 70). The positioning unit 20 is then precisely oriented with regard to the saw blade S and thus with the hand-held circular saw 70.

FIG. 17 shows a further design variant of a positioning unit 20. The design of this positioning unit 20 is essentially equal to the design of the positioning unit 20 shown in FIGS. 1 to 16. In this respect, reference can be made to the above statements. Therefore, only the differences shall be explained below.

As FIG. 17 shows, the positioning unit 20 again has at least one additional component interface 29, to which or in which an additional component 60 can be mounted. FIG. 17 shows an example of a positioning unit 20 having two additional component interfaces 29 in the area of the cantilever arm 24.

In particular, the additional components 60 described in the previous examples can be mounted on the additional component interface 29 if they are appropriately formed in the transition area where they connect to the additional component interface 29.

FIG. 17 illustrates that the additional component interface 29 can be used to mount an additional component 60, which has a cutting width compensator 67.

The design of such an additional component 60 is shown as an example in FIG. 18.

As this embodiment illustrates, the add-on component 60 may include a connection section 62 adapted to connect the add-on component 60 to the add-on component interface 29. For this purpose, provision may be made for the connection section 62 to have a bearing surface 62.4 with which it rests on an upwardly directed guide surface 29.2, preferably to form a linear guide.

Additionally or alternatively, provision may be made for the additional component 60 to have a guide area 62.5, which forms a guide, in particular a linear guide, with a guide element 29.3 of the positioning unit, in particular the additional component interface 29. The guide area 62.5 may be formed by a lateral casing, which is guided linearly on a guide surface of the guide element 29.3. Preferably, the guide direction of the additional component 60 extends vertically to the cutting direction of the hand-held circular saw 70.

FIG. 18 further illustrates that the additional component 60 has a fastening mount 62.2, which can preferably be in the form of an elongated hole. A fastening element 62.3 can be passed through the fastening mount 62.2. For instance, the fastening element 62.3 may be a fastening screw that is screwed into a threaded mount 29.1 of the positioning unit 20.

If provision is made for the additional component 60 to have a recess 62.6, inside of which the screw head of the fastening element 62.3 is at least partially mounted, a compact design is implemented, as FIG. 18 illustrates.

The sliding guide of the additional component 60 can be adjusted perpendicular to the feed direction of the hand-held circular saw 70. The adjustment is facilitated by a handle 62.7 of the additional component 60. As FIG. 19 illustrates, the handle 62.7 may have a textured surface to facilitate operation.

FIG. 18 further shows that the additional component 60 has a cutting width compensator 67. The cutting width compensator 67 can be integrally coupled to the connection section 62 by means of a component support 61. Preferably, the cutting width compensator 67 is held offset in the direction of the bottom face of the positioning unit 20 by means of the component support 61. For instance, a support surface 67.3 of the cutting width compensator 67 at the bottom face may be held at a small distance from the top face of a workpiece 100 (see FIG. 19), or ideally rest on the top face of this workpiece 100.

The cutting width compensator 67 has a marking edge 67.2, which preferably has the form of an edge. The marking edge 67.2 can be formed on a lug 67.1, as illustrated in FIG. 18.

The cutting width compensator 67 can be used to at least partially take the cutting width of a saw blade S of the hand-held circular saw 70 into account during the work process. This is explained in more detail in FIGS. 19-24 below.

FIG. 19 shows the assignment of the positioning unit 20 to a workpiece 100. For the sake of clarity, the guide rail is not shown in the drawing.

As explained above, the guide rail can be placed on the top face of the workpiece 100, the positioning unit 20 can be suitably attached to the guide rail and a saw cut 100 can be made with the hand-held circular saw 70, for instance in the form of a test cut in a test workpiece 100. This results in the saw slot 101. The saw slot 101 has an outer saw slot boundary 102 (facing away from the fastening section 21) and an inner saw slot boundary 103 (facing the fastening section 21), as FIG. 20 shows more clearly. Once the saw slot 101 has been inserted, the cutting width compensator 67 can be aligned, for instance to the outer saw slot boundary 102, for which purpose the marking edge 67.2 is brought into alignment with the outer saw slot boundary 102. This is illustrated in FIG. 20. The additional component 60 can then be firmly and immovably connected to the positioning unit 20 by means of the fastening element 62.3.

FIG. 19 shows the positioning unit 20, which forms the left-side stop limit for the hand-held circular saw 70 in FIG. 1. In the same way, the right-hand positioning unit 20, which limits the end of the saw cut 101 with its end-position stop 23.1, can also be equipped with a cutting width compensator 67. This second cutting width compensator 67 can therefore also be aligned with the outer saw slot boundary 102.

If the positioning units 20 set in this way are now aligned with their cutting width compensators 67 on a workpiece 100 to be machined to a mark located thereon, the user can take the width of the saw blade S precisely into account when creating the saw slot 101.

FIGS. 21 and 22 illustrate that it is not only possible to align the cutting width compensator 67 with the outer saw slot boundary 102. Rather, it is also possible to align the cutting width compensator 67 exactly to the center of the saw slot 101 between the inner saw slot boundary 103 and the outer saw slot boundary 102.

FIGS. 23 and 24 illustrate that the cutting width compensator 67 can be adjusted within a larger adjustment range, preferably infinitely variable. This takes into account that saw blades S having different saw blade widths can be fitted to the hand-held circular saw 70.

FIG. 25 shows a further design variant of a positioning unit 20. The design of this positioning unit 20 is essentially equal to the design of the positioning unit 20 shown in FIGS. 1 to 24. In this respect, reference can be made to the above statements. Therefore, only the differences shall be explained below.

The positioning unit 20 has an additional component interface in the area of the free end of the cantilever arm 24. In addition, an additional component interface 29 can also be provided on the holder 21.4 on the opposite end. Preferably, the additional component interfaces 29 are identical.

The additional component interface 29 has at least one protrusion 29.4, which engages with a recess 62.9 of the additional module 60 to align this additional module 60 with respect to the positioning unit 20. Of course, it is also conceivable that the positioning unit 20 has the recess 62.9 and the additional module 60 has the protrusion 29.4.

The additional component interface 29 may be equipped with a magnet for attaching the additional component 60, which interacts with a counter magnet of the additional component 60 to interchangeably hold the additional component 60 on the positioning unit 20.

FIGS. 26 and 27 show the structure of the additional component 60 in more detail. As these figures illustrate, the additional component 60 has a component support 61, which can be made, for instance, from a sheet metal blank and formed as a stamped-bent part. The component support 61 has at least one connection section 62, which is preferably provided with the recess or recesses 62.9. In this exemplary embodiment, 2 connection sections 62 are used, which are preferably of identical design.

As FIG. 27 illustrates, the two connection sections 62 may be designed as wall elements that are disposed spaced apart from one another. In the area between the connection sections 62, the component support 61 forms a mount for a supporting part. The supporting part is equipped with a guide surface 62.5 on the bottom end, which is placed on a support surface formed between the two connection sections 62.

The supporting part is provided with an aperture that forms a fastening mount 62.2. A fastening element 62.3 in the form of a threaded bolt can be inserted through this fastening mount 62.2. The threaded bolt can project from the guide surface 62.5.

A nut 69 is used to secure the supporting part to the component support 61. It can be screwed onto the fastening element 62.3 to clamp the supporting part to the component support 61. If the nut 69 is loosened, the supporting part can be adjusted at right angles to the cutting direction of the hand-held circular saw 70 in relation to the component support 61. For guided adjustment, a linear guide is formed between the supporting part and the component support 61. Here provision may be made for counter-guide elements 62.8 to be provided on the supporting part, which interact with guides 68 of the component support 61.

The counter-guiding elements 62.8 may form protrusions, which project on the bottom face of the supporting part and which engage with guides 68 of the component support 61 formed as recesses, as FIG. 27 shows.

The supporting part has a lug 67.1 on both ends adjacent to the fastening mount 62.2. Each of these lugs 67.1 is equipped with at least one marking edge 67.2. In this exemplary embodiment, a marking edge 67.2 is provided on opposite ends of each of the lugs 67.1. The bottom face of the lugs 67.1 may form a support surface 67.3, which faces the top face of a workpiece 100 to be machined.

FIG. 26 shows the assembly state of the additional component 60. To connect this additional component 60 to the positioning unit, the at least one recess 62.9 of the component support 61 merely has to be pushed onto the assigned protrusion 29.4. The magnetic connection between the additional component 60 and the positioning unit 20 then becomes effective, such that the additional component 60 is secured in orientation with the positioning unit 20. The assembled state is shown in FIG. 25.

According to a preferred variant, it is possible for the additional component 60 to be mounted on the additional component interface 29 of the cantilever arm 24 or the holder 21.4 as desired by the user. FIG. 33 shows the assembly on the holder 21.4. In the same way as in the exemplary embodiment according to FIGS. 17-24, the additional component 60 mounted on the positioning unit 20 can again be used to make a test cut in a test workpiece 100, and the position or width of the saw blade S can be taken into account. For this purpose, the cutting width compensator 67 or the two cutting width compensators 67 provided on the supporting part are oriented to the generated saw slot 101.

FIG. 28 shows the alignment at the outer saw slot boundary 102 and FIGS. 29 and 30 show the alignment of the cutting width compensators 67 in the center of the saw slot 101.

Similar to FIGS. 23 and 24, FIGS. 31 and 32 show the maximum lateral positioning of the cutting width compensators 67.

1-17. (canceled)

18. A positioning unit for positioning a hand-held circular saw on a guide rail, the positioning unit comprising:
a fastening section configured to interchangeably fasten the positioning unit to the guide rail;
an end-position stop and/or an initial-position limit stop configured to limit movement of the hand-held circular saw along the guide rail in a guide direction and/or in a direction opposite to the guide direction;
at least one additional component interface; and
at least one additional component interchangeably attached to the at least one additional component interface.

19. The positioning unit of claim 18, further comprising:
a cantilever arm coupled to the fastening section, the at least one additional component interface being defined on an end area of the cantilever arm opposite from the fastening section to hold the additional component adjacent a contact edge of the guide rail.

20. The positioning unit of claim 18, wherein:
the additional component includes a bearing part which bears a connection section held on a mount of the additional component interface.

21. The positioning unit of claim 18, wherein:
the additional component includes a connection section configured such that the additional component can be connected to the additional component interface in a plurality of different positions and/or orientations.

22. The positioning unit of claim 20, wherein:
the connection section includes at least one snap-in mount configured such that the connection section can be fastened to a mating snap-in element of the additional component interface.

23. The positioning unit of claim 20, wherein:
the connection section includes an adjustment device configured such that the connection section can be adjusted in position relative to the additional component interface either infinitely variably or in steps.

24. The positioning unit of claim 20, wherein:
the additional component includes a component support rotatably and/or swivel connected to a bearing part.

25. The positioning unit of claim 18, further comprising:
a detachable force-locking connection and/or a material bond provided between the additional component and the additional component interface.

26. The positioning unit of claim 18, wherein:
the additional component can be adjusted in position relative to the positioning unit infinitely variably or in steps transverse to the guide direction.

27. The positioning unit of claim 18, wherein:
the additional component includes a lamp, a chip collection hood, a bright light, a laser or a cutting width compensator.

28. The positioning unit of claim 18, wherein:
the additional component includes a chip collection hood including a discharge connection for connecting a dust extraction system.

29. The positioning unit of claim 18, further comprising:
a cantilever arm coupled to the fastening section, the at least one additional component interface being defined on an end area of the cantilever arm opposite from the fastening section to hold the additional component adjacent a contact edge of the guide rail; and
a cutting-length setting element connected to the fastening section or the cantilever arm and projecting in the guide direction or in an opposite direction from the guide direction.

30. The positioning unit of claim 18, wherein:
the additional component includes a cutting width compensator including a marking edge on at least one lug extending in the guide direction.

31. The positioning unit of claim 30, further comprising:
a sliding guide connecting the cutting width compensator to the positioning unit, the sliding guide being configured such that the cutting width compensator is movable relative to the positioning unit in a direction transverse to the guide direction.

32. The positioning unit of claim 18, further comprising:
a kick-back stop configured to engage the hand-held circular saw to prevent the hand-held circular saw from lifting off of the guide rail toward a user of the hand-held circular saw.

33. The positioning unit of claim 18, wherein:
the fastening section includes at least one downwardly open recess and a clamping element movable between a release position and a clamping position, the clamping element at least partially engaging the at least one recess in the clamping position and the clamping element disengaging the at least one recess in the release position.

34. The positioning unit of claim 18, wherein:
the positioning unit further includes a recessed linear guide mount and a projecting protrusion spaced at a distance from the recessed linear guide mount, the recessed linear guide mount and the projecting protrusion being configured for engagement with the guide rail.

35. A guide assembly for a hand-held circular saw, comprising:
a guide rail including a guide groove and/or a guide bar extending in a guide direction, the guide rail including a longitudinal fastening end extending in the guide direction and a cutting-edge end opposite from the longitudinal fastening end, the cutting-edge end including a contact edge;
at least one positioning unit including a fastening section configured to interchangeably fasten the positioning unit to the guide rail, an end-position stop and/or an initial-position limit stop configured to limit movement of the hand-held circular saw along the guide rail in a guide direction and/or in a direction opposite to the guide direction, and at least one additional component interface; and
an additional component interchangeably attached to the at least one additional component interface and held laterally next to the contact edge.
